(19) United States
(12) Patent Application Publication
(10) Pub. No.: US 2016/0273250 A1
(43) Pub. Date: Sep. 22, 2016

(54) LOCKING SYSTEM, AND OPENING AND CLOSING DEVICE

(71) Applicant: MITSUBISHI STEEL MFG. CO., LTD., Tokyo (JP)

(72) Inventor: Takao ENDO, Chiba (JP)

(73) Assignee: MITSUBISHI STEEL MFG. CO., LTD., Tokyo (JP)

(21) Appl. No.: 15/030,945

(22) PCT Filed: Nov. 27, 2014
(86) PCT No.: PCT/JP2014/081433

§ 371 Date: Apr. 21, 2016

(30) Foreign Application Priority Data
Dec. 6, 2013 (JP) 2013-253494
Mar. 3, 2014 (JP) 2014-040136

(51) Int. Cl. E05C 19/02; B65D 43/22; A45D 40/22; E05B 65/52; E05C 3/12

(52) U.S. Cl. CPC E05C 19/02; E05B 65/52; E05C 3/12; A45D 40/222; B65D 43/22; A45D 2040/223

(57) ABSTRACT

A locking system fixes, to a first member, a second member pivotably attached to a first member. The locking system includes a lock pin; a locking member that moves as the lock pin travels; and a first biasing member that biases the locking member. The locking member includes a cam groove, wherein the lock pin enters and travels inside the cam groove in accordance with the pivoting movement of the second member. The cam groove includes a locking portion that locks the lock pin when the second member is moved to a position where the second member is fixed to the first member, wherein the locking portion releases the locking of the lock pin when the lock pin in a locked state being pressed. A moving direction of the locking member is set to be different from a direction in which the lock pin enters the cam groove.

### TECHNICAL FIELD

An embodiment of the present invention relates to a locking system and an opening and closing device.

### BACKGROUND ART

In general, a container with a lid where an openable and closable lid is attached to a container main body has been used in many cases. In such a container with a lid, an opening and closing device for the lid is installed, and the lid is opened and closed with respect to the container by the opening and closing device.

In a system in which a lid freely opens and closes, the lid may be unintentionally opened. Thus, there is provided an opening and closing device having a locking system that can lock a lid in a state in which the lid is closed.

A locking system (which is referred to as a first locking system) has been known (cf. Patent Document 1) such that a fitting concave portion is provided at a U-shaped fitting portion formed in a lid, and a fitting convex portion is provided in a container main body. According to the first locking system, upon the lid being closed, the fitting concave portion fits with the fitting convex portion, and thereby the lid is locked in a closed state.

Additionally, as another locking system, a locking system (which is referred to as a second locking system) has been known (cf. Patent Document 2) such that an engagement protrusion is provided in a lid, and a bent hook-shaped claw is provided in a container main body. In the second locking system, upon the lid being closed, the engagement protrusion provided in the lid engages with the bent hook-shape claw of the container body, thereby locking the lid.

### SUMMARY OF INVENTION

### Technical Problem

When the above-described first locking system is used, for opening the lid, fitting between the fitting concave portion and the fitting convex portion is released by pressing the U-shaped fitting portion, so that the U-shaped fitting portion is elastically deformed, and the lid is opened while maintaining this state. Thus, a problem with the second locking system is that operability is poor.

When the above-described second locking system is used, for opening the lid, first the bent portion and the engagement protrusion are separated by moving the lid in its surface direction (the horizontal direction). After that, the engagement between the engagement protrusion and the bent hook-shaped claw is released by opening the lid, while maintaining the moved state. Consequently, a problem with the second locking system is also that operability is poor.

An object of an embodiment of the present invention is to enhance operability for opening a locked lid.

### Solution to Problem

According to an embodiment of the present invention, there is provided a locking system for fixing a second member to a first member, the second member being pivotably attached to the first member, wherein the locking system includes a lock pin; a locking member that moves as the lock pin travels; and a first biasing member that biases the locking member. The locking member includes a cam groove, wherein the lock pin enters and travels inside the cam groove in accordance with a pivoting movement of the second member. The cam groove includes a locking portion that locks the lock pin, when the second member is moved to a position at which the second member is fixed to the first member, wherein the locking portion releases the lock pin, when the lock pin in a locked state is pushed into the locking portion. A moving direction of the locking member is set to be different from a direction in which the lock pin enters the cam groove.

According to another embodiment of the present invention, there is provided an opening and closing device including the above-described locking system.

Other objects, features and advantages of the present invention will become more apparent from the following detailed description when read in conjunction with the accompanying drawings.

### Advantageous Effects of Invention

According to an embodiment of the present invention, operability for opening a locked lid can be enhanced by using a simple structure.

### BRIEF DESCRIPTION OF DRAWINGS

FIG. 1A is a perspective view of a container including an opening and closing device according to an embodiment, wherein a lid is opened;

FIG. 1B is a perspective view of the container including the opening and closing device according to the embodiment, wherein the lid is closed;

FIG. 2A is a plane view of a locking system included in the opening and closing device according to the embodiment;

FIG. 2B is a front view of the locking system included in the opening and closing device according to the embodiment;

FIG. 2C is a side view of the locking system included in the opening and closing device according to the embodiment;

FIG. 3A is a plane view of a locking member included in the opening and closing device according to the embodiment;

FIG. 3B is a front view of the locking member included in the opening and closing device according to the embodiment;

FIG. 3C is a side view of the locking member included in the opening and closing device according to the embodiment;

FIG. 4A is a plane view of a guide member included in the opening and closing device according to the embodiment;

FIG. 4B is a front view of the guide member included in the opening and closing device according to the embodiment;

FIG. 4C is a side view of the guide member included in the opening and closing device according to the embodiment;

FIG. 5 is a perspective view of the locking system for illustrating an operation of the opening and closing device according to the embodiment;

FIG. 6 is a perspective view of the locking system for illustrating the operation of the opening and closing device according to the embodiment;

FIG. 7 is a perspective view of the locking system for illustrating the operation of the opening and closing device according to the embodiment;

FIG. 8 is a perspective view of the locking system for illustrating the operation of the opening and closing device according to the embodiment;

FIG. 9 is a perspective view of the locking system for illustrating the operation of the opening and closing device according to the embodiment;

FIG. 10 is a perspective view of the locking system for illustrating the operation of the opening and closing device according to the embodiment;

FIG. 11 is a perspective view of a locker in which the opening and closing device according to the embodiment is installed;

FIG. 12A is a perspective view illustrating an operation of the opening and closing device according a modified example of the embodiment;

FIG. 12B is a perspective view illustrating the operation of the opening and closing device according to the modified example of the embodiment; and

FIG. 12C is a perspective view illustrating the operation of the opening and closing device according to the modified example of the embodiment.

### DESCRIPTION OF EMBODIMENTS

An exemplary non-limiting embodiment of the present invention is described while referring to the accompanying drawings.

In all of the accompanying drawings, the same or corresponding reference numerals are attached to the equivalent parts, and the description thereof is omitted. The drawings are not intended to indicate relative ratios between the members or components, unless as specified otherwise. Thus, a person ordinarily skilled in the art can determine a specific size in light of the following embodiment.

The embodiment described below is for exemplifying purposes only, and not for limiting the present invention. It may not be true that all the features and the combinations thereof described in the embodiment are essential to the present invention.

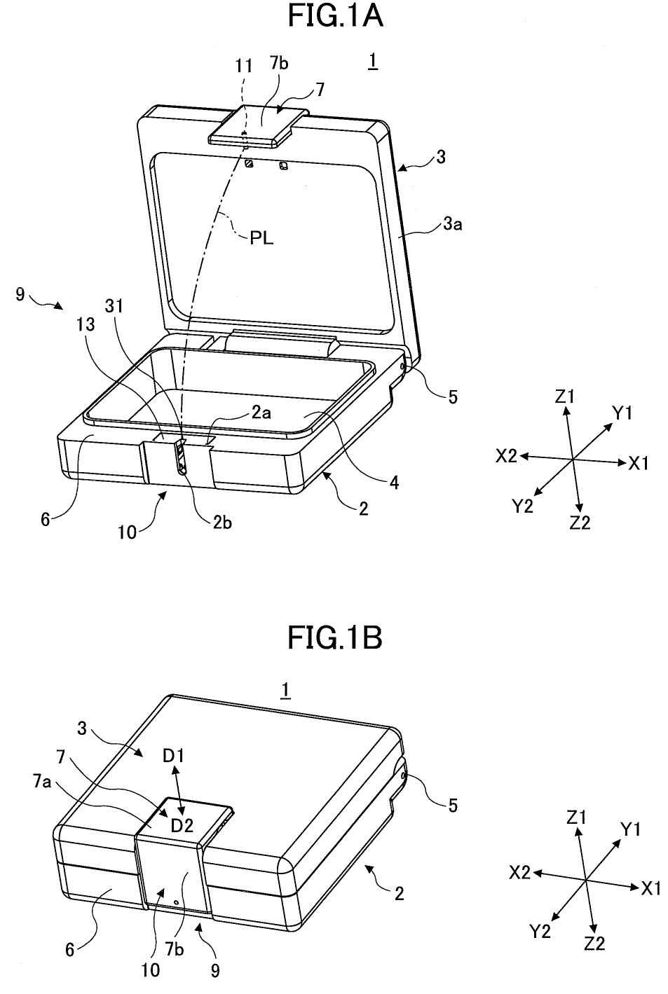

FIG. 1 illustrates a container 1 to which an opening and closing device 9 according to an embodiment of the present invention is applied. In the embodiment, an example is described in which the opening and closing device 9 is applied to a cosmetic container for accommodating cosmetics, such as makeup foundation.

The container 1 includes, for example, a container main body 2; a lid 3; and a locking system 10. The lid 3 is attached to the container main body 2, so that the lid 3 can be opened and closed. The container main body 2 includes an accommodating portion 4 for accommodating cosmetics, such as makeup foundation. The locking system 10 that forms the opening and closing device 9, which is described below, is installed in a front portion 6 that forms a front of the container main body 2.

The lid 3 is pivotably attached to the container main body 2 through a hinge 5. The lid 3 pivots around the hinge 5, as a center, so that the lid 3 can be at a position to open the accommodating portion 4 (which is referred to as the open position) with respect to outside, as illustrated in FIG. 1A; and that the lid 3 can be at a position to close the accommodating portion 4 (which is referred to as the closed position), as illustrated in FIG. 1B.

The lid 3 includes a lid main body 3a; and an operation part 7. In a state in which the lid 3 is in the closed position, the lid main body 3a is configured to cover an upper portion of the container main body 2.

The operation part 7 can be moved in the vertical direction (the direction indicated by the arrows D1 and D2 in FIG. 1B) with respect to a direction of the surface of the lid main body 3a. The operation part 7 has a configuration such that an upper plate portion 7a and a side plate portion 7b are integrally molded substantially in an L-shape. Further, in the operation part 7, a lock pin 11 is provided (which is described below), which is a part of the locking system 10.

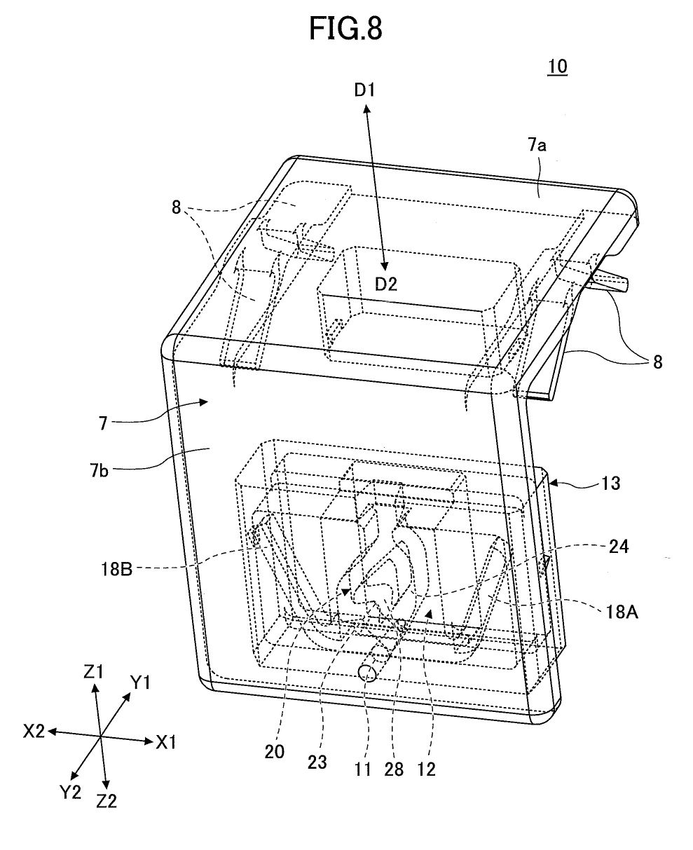

A spring member 8 (cf. FIG. 8) is disposed between the upper plate portion 7a of the operation part 7 and the lid main body 3a. The spring member 8 biases the operation part 7 against the lid main body 3a in an upward direction (a direction of the arrow D1). A stopper (not depicted) is provided between the upper plate portion 7a and the lid main body 3a, so that the operation part 7 is prevented from being detached from the lid main body 3a.

Next, the locking system 10 is described.

The locking system 10 includes, for example, the lock pin 11; a locking member 12; and a guide member 13.

The lock pin 11 is provided, so that the lock pin 11 protrudes inward from the side plate portion 7b of the operation part 7. The material of the lock pin 11 is not particularly limited. It suffices if the lock pin 11 is formed of a member having sufficient strength for locking the lid 3, which is described below.

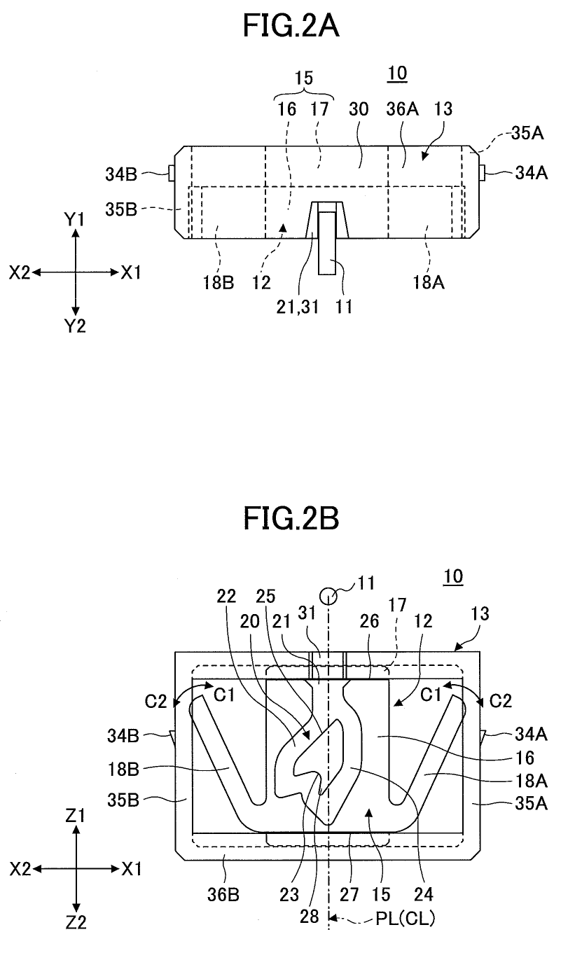

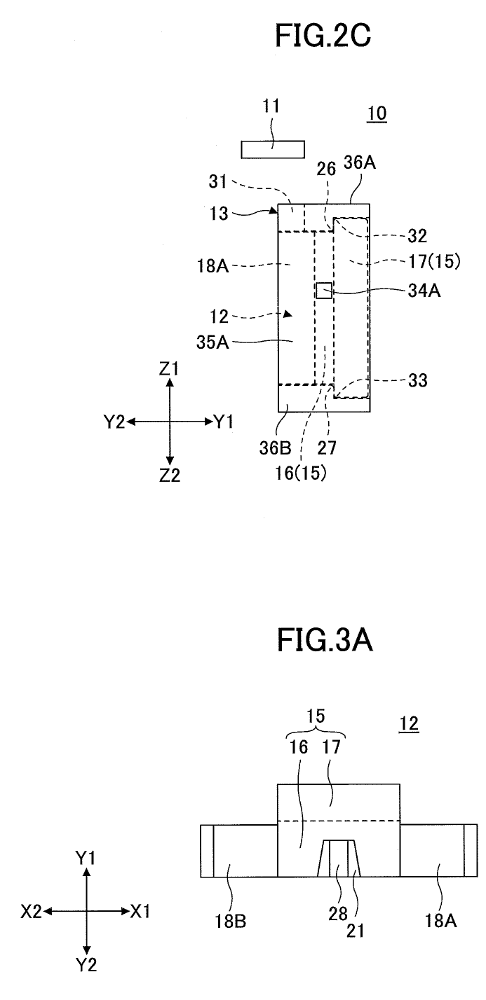

The lock pin 11 is moved as the lid 3 pivots because the lock pin 11 is provided in the operation part 7. At this time, the movement trajectory of the lock pin 11 is a line shaped trajectory that extends in the vertical direction (the direction indicated by the arrows Z1 and Z2 in the figure) in a front view. In a side view, the movement trajectory of the lock pin 11 is an arc-shaped trajectory, which is centered on the hinge 5. Note that, in FIG. 1A and FIG. 2B, the movement trajectory of the lock pin 11 is indicated by a chain line.

The locking member 12 and the guide member 13 are provided in the front portion 6, which forms a portion of the container main body 2. When the container 1 is used, the front portion 6 is a wall portion that forms the front of the container main body 2.

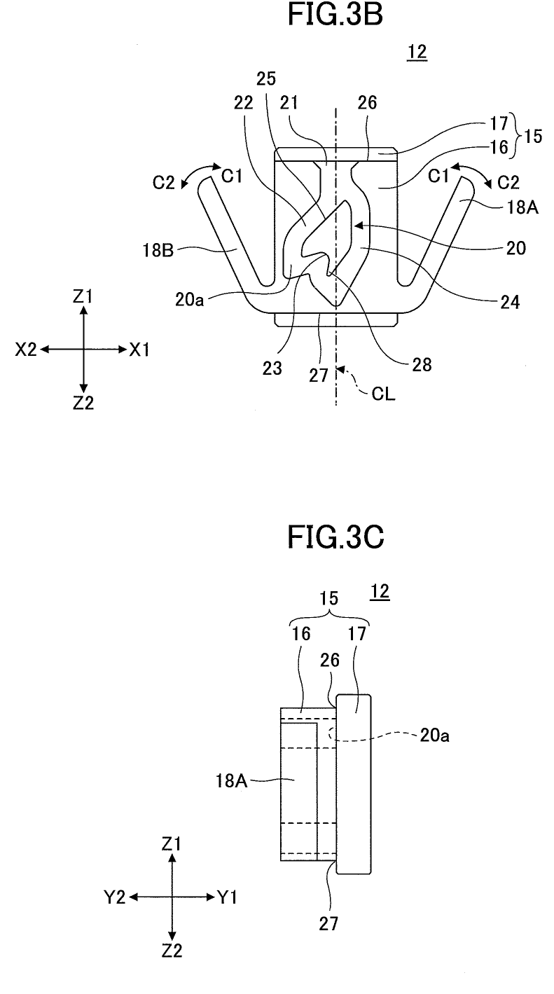

As illustrated in FIG. 2B, the locking member 12 is disposed inside the guide member 13. The locking member 12 can slide in a longitudinal direction (the directions of the arrows X1 and X2 in FIGS. 2A to 2C) inside the guide member 13. As illustrated in FIGS. 2A to 2C and FIGS. 3A to 3C, the locking member 12 includes a main body 15 and spring portions 18A and 18B.

In the embodiment, the main body 15 and the spring portions 18A and 18B are integrally molded with a resin. However, the main body 15 and the spring portions 18A and 18B may not be integrally molded. Additionally, a material of the main body 15 and the spring portions 18A and 18B is not limited to a resin, and a metal may be used, for example.

The main body 15 includes a cam forming portion 16 and a slide portion 17. The cam forming portion 16 is positioned in a front side (in the figures, the side of the arrow Y2 is the front side). The slide portion 17 is positioned behind the cam forming portion 16 (the side of the arrow Y1).

The can forming portion 16 and the slide portion 17 are formed so that their heights in the vertical direction (the directions of the arrows Z1 and Z2) are different. Specifically, the height of the slide portion 17 is greater than the height of the cam forming portion 16. By this difference in the heights, between the cam forming portion 16 and the slide portion 17, an upper step portion 26 is formed at an upper portion, and a lower step portion 27 is formed at a lower portion.

The cam forming portion 16 has a heart cam portion 20. The heart cam portion 20 includes, for example, a pin insertion and removal opening 21; a pin entrance side cam groove 22; a concave engaging portion 23; and a pin disengage side cam groove 24. As illustrated in FIG. 3B, in a front view of the locking member 12, in the heart cam portion 20, from the pin insertion and removal opening 21, the pin entrance side cam groove 22, the concave engaging portion 23, and the pin disengaging side cam groove 24 are continuously formed substantially in a circular shape, in counterclockwise.

In the embodiment, an inner surface 20a (which is a surface facing a tip of the lock pin 11 in the direction of the arrow Y1) facing the lock pin 11 of the heart cam portion 20 is formed to be a flat surface without unevenness. Thus, the heart cam portion 20 can be easily formed. Consequently, the locking member 12 can be easily produced at low cost.

The pin insertion and removal opening 21 is an opening for inserting the lock pin 11 into and removing the lock pin 11 from the heart cam portion (cf. FIG. 2B). The pin insertion and removal opening 21 is formed at an upper portion in a substantially middle position of the locking member 12 in the slide direction (the directions of the arrows X1 and X2).

The pin entrance side cam groove 22, in a front view, extends obliquely downward toward left from the pin insertion and removal opening 21. An inner wall 25 that forms the pin entrance side cam groove 22 has a portion that faces the pin insertion and removal opening 21. Specifically, the wall 25 is formed so that, upon the lock pin 11 entering the heart cam portion 20 from the pin insertion and removal opening 21, the lock pin 11 first engages with the wall 25 (hereinafter, the wall 25 is referred to as an engaging wall 25).

The pin disengaging side cam groove 24 is formed between a protruding wall 28 and the pin insertion and removal opening 21. As described below, after climbing over the protruding wall 28, the lock pin 11 moves inside the pin disengaging side cam groove 24 toward the pin insertion and removal opening 21.

The concave engaging portion 23 is formed at a boundary portion between the pin entrance side cam groove 22 and the pin disengaging side cam groove 24. The concave engaging portion 23 is recessed inward, so that the lock pin 11 can be engaged.

The protruding wall 28 is formed at a side portion of the concave engaging portion 23. The protruding wall 28 is formed at a forward position (a position to the right of the concave engaging portion 23 in FIG. 2B) of the concave engaging portion 23 in the moving direction of the lock pin 11. The protruding wall 28h protrudes in the downward direction (the direction indicated by the arrow Z2 in the figure).

The above-described lock pin 11 is configured so that, during a state in which the lid 3 is closed (which is referred to as the closed state, hereinafter), the lock pin 11 is engaged by the concave engaging portion 23. In this engaged state, even if an attempt is made to move the lock pin 11 in a disengagement direction (namely, even if an attempt is made to move the lid 3 in the direction to open), the lock pin 11 does not become disengaged from the concave engaging portion 23 because the concave engaging portion 23 is recessed inward. Consequently, the lid 3 is in a state in which the lid 3 is locked in the closed state. The state where the lid 3 and the lock pin 11 are locked is referred to as a locked state, hereinafter.

Note that, upon engaging the lock pin 11 with the concave engaging portion 23, a click feeling can be provided to a user of the container 1. With the click feeling, the user of the container 1 can perceive that the lid 3 is locked.

Further, as described above, the protruding wall 28 is formed at the side portion of the concave engaging portion 23, which is at a side toward which the lock pin 11 is to be moved. Thus, the lock pin 11 that is locked by the concave engaging portion 23 may not immediately travel in the pin disengaging side cam groove 24. However, after climbing over the protruding wall 28, the lock pin 11 travels in the pin disengaging side cam groove 24, and the lock pin 11 travels toward the pin insertion and removal opening 21 while being guided by the pin disengaging side cam groove 24.

Here, the chain line illustrated in FIG. 3B is a center line CL with respect to the slide direction (the directions of the arrows X1 and X2) of the locking member 12. In the embodiment, the pin entrance side cam groove 22 and the concave engaging portion 23 are disposed to one side (the side in the direction of the arrow X2) with respect to the center line CL, and the pin disengaging side cam groove 24 is disposed to the other side of the center line CL (the side in the direction of the arrow X1).

Next, the spring portions 18A and 18B are described.

Each of the spring portions 18A and 18B is a cantilever structure such that the lower portion is fixed to the cam forming portion 16. Namely, in a front view of the locking member 12 (the state illustrated in FIG. 3B), the spring portion 18A extends obliquely upward toward right from the right lower portion of the cam forming portion 16. Similarly, in a front view of the locking member 12, the spring portion 18B extends obliquely upward toward left from the left lower portion of the cam forming portion 16. In this manner, each of the spring portions 18A and 18B forms a plate spring.

The spring portions 18A and 18B can be elastically deformed in the directions indicated by the arrows C1 and C2 in FIG. 3B. In a state where the locking member 12 is installed in the guide member 13, and the lock pin 11 is not inserted (which is referred to as a neutral state, hereinafter), the tip of the spring portion 18A contacts an inner wall of a side wall portion 35A of the guide member 13 (cf. FIG. 2B). Similarly, in the neutral state, a tip of the spring portion 18B contacts an inner wall of a side wall portion 35B of the guide member 13 (cf. FIG. 2B).

The spring portions 18A and 18B are symmetrical with respect to the center line CL. Further, the spring portions 18A and 18B are adjusted, so that their spring constants are the same.

Upon the locking member 12 having the above-described structure being moved from the neutral position toward the direction of the arrow X1 in the guide member 13, the spring portion 18A contacting the side wall portion 35A elastically deforms in the direction of the arrow C1. As a consequence, in the spring portion 18A, an elastic force is generated that biases the locking member 12 in an opposite direction (the direction of the arrow X2). Whereas, upon the locking member 12 being moved from the neutral position toward the direction of the arrow X2, the spring portion 18B contacting the side wall portion 35B elastically deforms in the direction of the arrow C1. Consequently, in the spring portion 18B, an elastic force is generated that biases the the locking member 12 in the direction of the arrow X1.

Next, the guide member 13 is described.

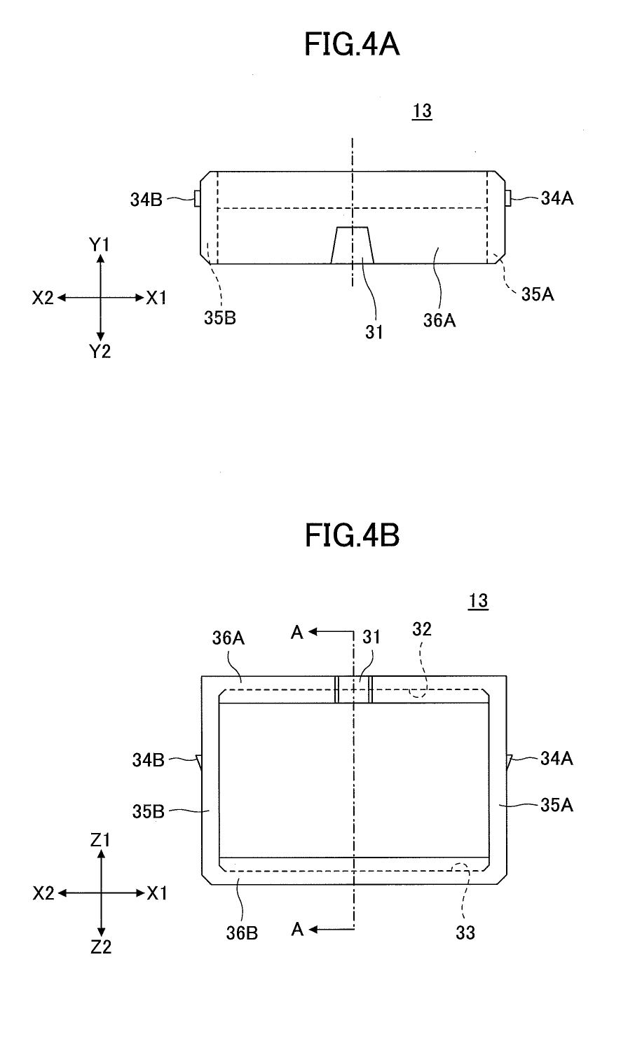

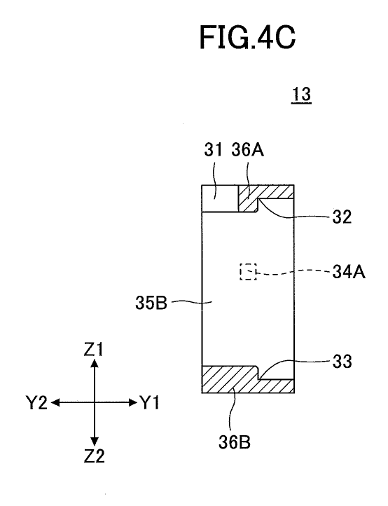

The guide member 13 includes the locking member 12 therein, and the guide member 13 guides the locking member 12, so that the locking member 12 slides (moves) in the directions of the arrows X1 and X2. The guide member 13 is configured such that the side wall portions 35A and 35B, the upper wall portion 36A, and the lower wall portion 36B are integrally molded. As illustrated in FIG. 4B, in a front view, the guide member 13 has a frame-like shape.

Note that, in the embodiment, the guide member 13 is an integrally molded product, which is formed of a resin. However, the guide member 13 may be formed of a metal. Alternatively, the wall portions 35A, 35B, 36A, and 36B may be formed of different materials, and the guide member 13 having the frame shape may be formed by bonding these members.

On the external walls of the side wall portions 35A and 35B, installation protrusions 34A and 34B are formed, respectively. The guide member 13 is inserted into and installed in a system accommodation portion 2a, which is formed in the front portion 6 of the container main body 2 (cf. FIG. 1A). In this state, the installation protrusions 34A and 34B engage with respective installation concave portions (not appear in the figures), which are formed in the internal walls of a system accommodation portion 2a. In this manner, the guide member 13 is attached to the container main body 2 (the front portion 6), as the installation protrusions 34A and 34B engage the corresponding installation concave portions.

In the upper wall portion 36A of the guide member 13, a groove portion 31 is formed, into which the lock pin 11 is to be inserted, upon the lid 3 being closed. The groove portion 31 is formed on a movement trajectory PL of the lock pin 11. In addition, the groove 31 is configured so that the groove 31 faces the pin insertion and removal opening 21 when the locking member 12 is in the neutral state.

An upper step portion 32 is formed in the upper wall portion 36A, and a lower step portion 33 is formed in the lower step portion 33. The upper step portion 32 of the guide member 13 slidably engages with the upper step portion 26 formed in the locking member 12. Additionally, the lower step portion 33 of the guide member 13 slidably engages with the lower step portion 27 formed in the locking member 12. By slidably engaging the upper step portions 26 and 32, and by slidably engaging the lower step portions 27 and 33, the locking member 12 can be stably moved in the guide member 13.

Note that, in the front portion 6 of the container main body 2, a pin groove 2b is formed to allow the lock pin 11 to enter inside the locking system 10, as the lid 3 is moved.

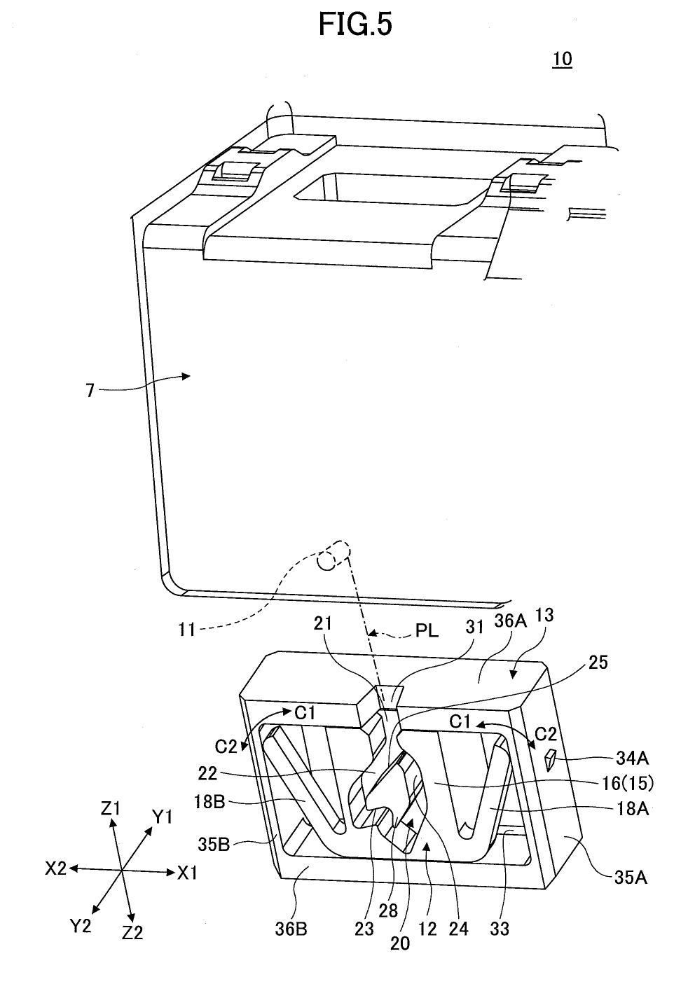

Next, operation of the locking system 10 is described while referring to FIGS. 5 to 10.

First, operation of the locking system 10 is described for moving the lid 3 from the open position, which is illustrated in FIG. 1A, to the closed position, which is illustrated in FIG. 1B.

Upon closing the lid 3 from the open position illustrated in FIG. 1A around the hinge 5, the lock pin 11 installed in the lid 3 moves on the movement trajectory PL in accordance with this movement. FIG. 5 illustrates a state in which the lock pin 11 is moved to the vicinity of the locking member 12 and the guide member 13. Note that, in FIGS. 5 to 10, depiction of the container 1 is suitably omitted to simplify the figures.

In the state illustrated in FIG. 5, the lock pin 11 is not entering inside the locking member 12. Thus, the locking member 12 is in the neutral state where it is positioned at a middle position of the guide member 13. In the neutral state, the pin insertion and removal opening 21 of the locking member 12 faces the groove portion 31 formed in the upper wall portion 36A of the guide member 13. Additionally, in the neutral state, the spring portions 18A and 18B contact the inner walls of the side wall portions 35A and 35B, respectively.

Upon further closing the lid 3 from the state illustrated in FIG. 5, the lock pin 11 passes through the pin insertion and removal opening 21, and enters inside the heart cam portion 20 formed in the locking member 12. As illustrated in FIG. 2B, the engaging wall 25 that forms the pin entrance side cam groove 22 in the heart cam portion 20 has a portion that faces the pin insertion and removal opening 21 and the groove portion 31. In other words, the engaging wall 25 is configured so that the engaging wall 25 intersects the movement trajectory PL of the lock pin 11.

Thus, upon moving the lock pin 11 in the pin insertion and removal opening 21 through the groove portion 31, the lock pin 11 engages with the engaging wall 25. Consequently, the lock pin 11 enters inside the pin entrance side cam groove 22 while guided by the engaging wall 25.

As described above, the lock pin 11 moves so as to draw the movement trajectory PL. In a front view, the movement trajectory PL is a straight line shaped trajectory, as illustrated in FIG. 2B. Whereas, the locking member 12 can be moved inside the guide member 13 in a direction perpendicular to the movement trajectory PL (the directions indicated by the arrows X1 and X2 in the figure). Furthermore, the pin entrance side cam groove 22 is provided at a position that is shifted with respect to the center line CL (the position at the left side in FIG. 2B and FIG. 3B).

In the neutral state, the movement trajectory PL coincides the center line CL of the locking member 12. However, upon the lock pin 11 entering the pin entrance side cam groove 22, the lock pin 11 presses the engaging wall 25 of the locking member 12. Consequently, the locking member 12 is biased to move in the direction indicated by the arrow X1.

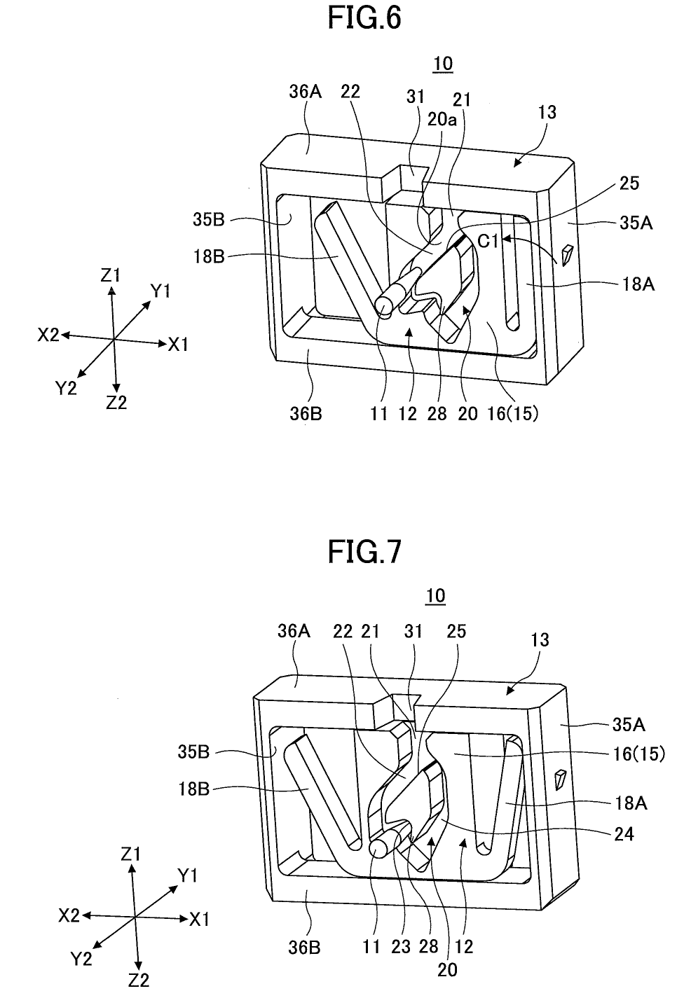

FIG. 6 illustrates a state in which the lock pin 11 enters the pin entrance side cam groove 22 while guided by the engaging wall 25, and thereby the locking member 12 is moved in the direction of the arrow X1.

Upon the locking member 12 being moved in the direction of the arrow X1, the spring portion 18A is pressed against to the side wall portion 35A, and is elastically deformed in the direction of the arrow C1. By the elastic restoring force of the spring portion 18A, a force is applied to the locking member 12 to move in the direction of the arrow X2 in the figure. The lock pin 11 is pressed against the engaging wall 25 by the elastic restoring force, and while maintaining this state, the lock pin 11 is moved in the direction of the arrow Z2 in the figure (moves downward).

Upon the lock pin 11 being further moved, as illustrated in FIG. 7, the lock pin 11 eventually reaches a position where the concave engaging portion 23 is formed.

As described above, the concave engaging portion 23 is recessed inward (obliquely upward toward right, in a front view). Further, the protruding wall 28, which extends downward (the direction of the arrow Z2), is formed at a front side portion of the concave engaging portion 23, with respect to the the traveling direction of the lock pin 11. Furthermore, the locking member 12 is biased in the direction of the arrow X2 in the figure by the elastic restoring force of the spring portion 18A.

Consequently, upon the lock pin 11 reaching the position where the concave engaging portion 23 is formed, the lock pin 11 engages the concave engaging portion 23, while guided by the protruding wall 28. As described above, upon the lock pin 11 being engaged with the concave engaging portion 23, a click feeling is provided to the user of the container 1. Thus, upon detecting the click feeling, the user stops the operation to close the lid 3.

As described above, the operation part 7, in which the lock pin 11 is formed, is biased, by the spring member 8, in the upward direction (the direction of the arrow D1) with respect to the lid main body 3a. Thus, when the user stops the operation to close the lid 3, the lock pin 11 is biased in the upward direction (the direction indicated by the arrow D1 in FIG. 1B and FIG. 8) by the spring member 8. Consequently, the lock pin 11 is pressed against the concave engaging portion 23, and the lock pin 11 is in a state where it is locked in the concave engaging portion 23.

In this manner, as illustrated in FIG. 1B, the lid 3 is locked by locking the lock pin 11 in the concave engaging portion 23. In this closed state, even if a force is applied in the direction to open the lid 3, the lid 3 does not open because this force is applied so as to press the lock pin 11 against the concave engaging portion 23.

The elastic force generated by the spring member 8 is applied to relatively press the lid 3 toward the container main body 2 because the lock pin 11 is locked in the concave engaging portion 23. Thus, in a state where the lid 3 is locked, airtightness of the accommodating portion 4 may also be maintained by pressing the lid 3 against the container main body 2.

Next, operation of the locking system 10 is described for moving the lid 3 from the closed position, which is illustrated in FIG. 1B, to the open position, which is illustrated in FIG. 1A.

In order to release the locking between the lock pin 11 and the concave engaging portion 23 to allow the lid 3 to move to the open state, the operation part 7 of the lid 3, which is at the closed position, is pressed (pressed in the direction of the arrow D2). By doing this, the operation part 7 is moved in the direction of the arrow D2 against the elastic force of the spring member 8, and, in accordance with the movement, the lock pin 11, which is formed in the operation part 7, is also moved in the direction of the arrow D2. Note that the direction of the arrow D2 is substantially the same as the direction of the arrow Z2 in the closed state.

As described above, the locking member 12 is biased in the direction of the arrow X2 by the elastic restoring force of the spring portion 18A. Consequently, the lock pin 11 is pressed against the protruding wall 28. Thus, when the lock pin 11 is moved in the direction of the arrow Z2, the lock pin 11 moves in the direction of the arrow Z2 while guided by the protruding wall 28.

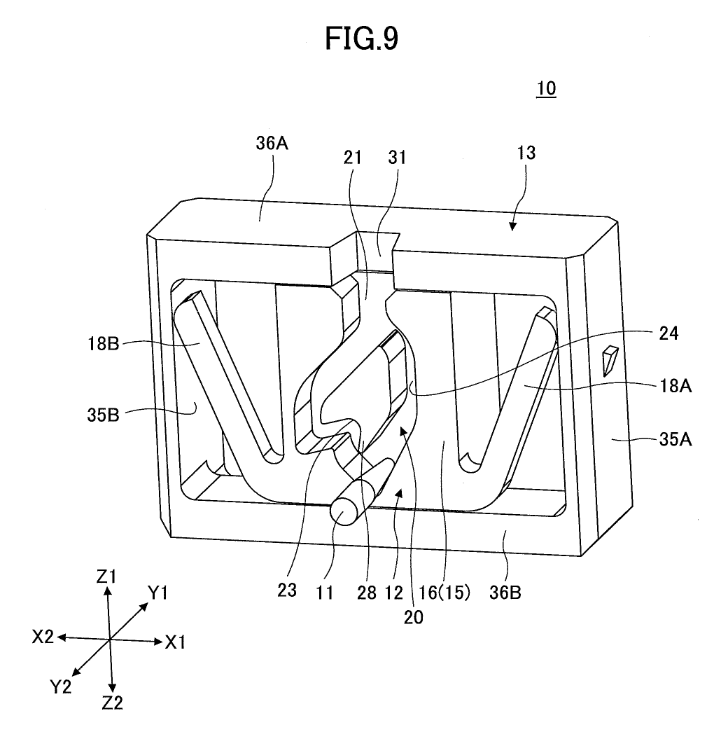

After the lock pin 11 is moved in the direction of the arrow Z2, the lock pin 11 is in a state where the lock pin 11 climbs up the protruding wall 28. FIG. 8 and FIG. 9 illustrate the state where the lock pin 11 climbs up the protruding wall 28.

In this manner, upon the lock pin 11 climbing up the protruding wall 28, the locking member 12 moves in the direction of the arrow X2 by the elastic restoring force of the spring portion 18A, and the lock pin 11 travels in the pin disengaging side cam groove 24. The pin disengaging side cam groove 24 is a cam groove formed toward the pin insertion and removal opening 21. Thus, as the lock pin 11 passes through the pin disengaging side cam groove 24, locking of the lock pin 11 by the concave engaging portion 23 is released. Then, the lid 3 is in a state in which the lid 3 can be moved toward the opened state (unlocked state).

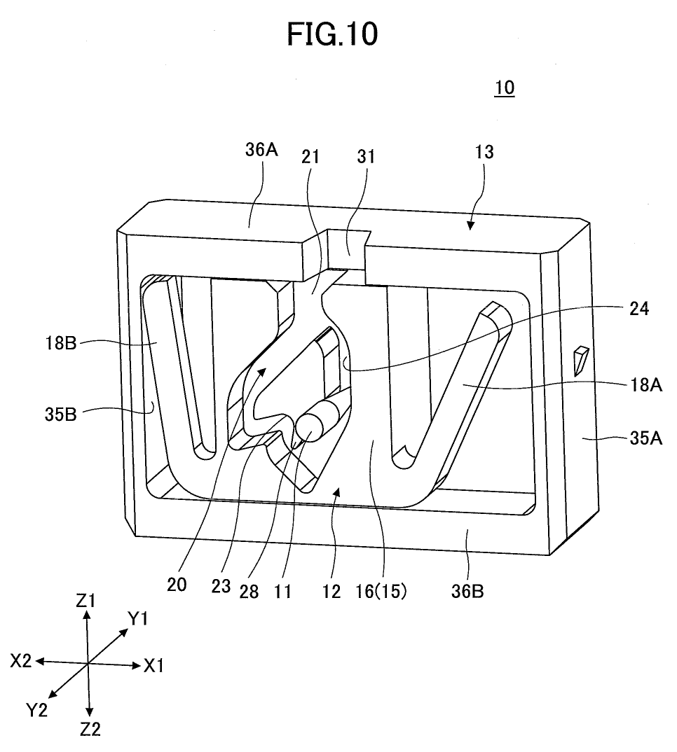

In the unlocked state, upon the lid 3 being pivoted toward the opened state by the user, the lock pin 11 moves upward (the direction of the arrow Z1) in the pin disengaging side cam groove 24, as illustrated in FIG. 10. Then, the lock pin 11 is separated from the locking member 12 and the guide member 13 through the pin insertion and removal opening 21 and the groove portion 31. In this manner, the lid 3 can be pivoted toward the open position, which is illustrated in FIG. 1A.

As described above, in the embodiment, the locking system 10 for locking the lid 3 to the container main body 2 is mainly formed of the lock pin 11 and the locking member 12. Thus, the locking system 10 can securely lock the lid 3 to the container main body 2 with the simple structure. Consequently, by using the locking system 10, the container 1 can be prevented from being increased in size.

Especially, in a front view, the direction in which the locking member 12 is moved is in the direction perpendicular to the traveling direction (the directions of the arrows Z1 and Z2) of the lock pin 11 (the movement trajectory PL), and the the direction in which the locking member 12 is moved coincides the direction in which the front portion 6 of the container main body 2 is extended. Consequently, the thickness of the front portion 6 (the sizes of the arrows Y1 and Y2) can be reduced, and the the size of the container 1 may also be reduced.

Further, in the locking system 10 according to the embodiment, the operation for the user to lock the lid 3 to the container main body 2 and to release locking is simply the operation to press the lid 3 (the operation part 7). Consequently, each of the operation to lock the lid 3 to the container main body 2 and the operation to release locking can be easily performed by one-touch operation. Specifically, for example, it is not necessary, while supporting the container main body 2 by one hand, to open and close the lid 3 by another hand, so that the lid 3 can be opened and closed by one hand. In this manner, operability of the container 1 can be enhanced.

In the above-described embodiment, the opening and closing device 9 is applied to the cosmetic container 1. However, the present invention is not limited to the cosmetic container, and can be broadly applied to other containers.

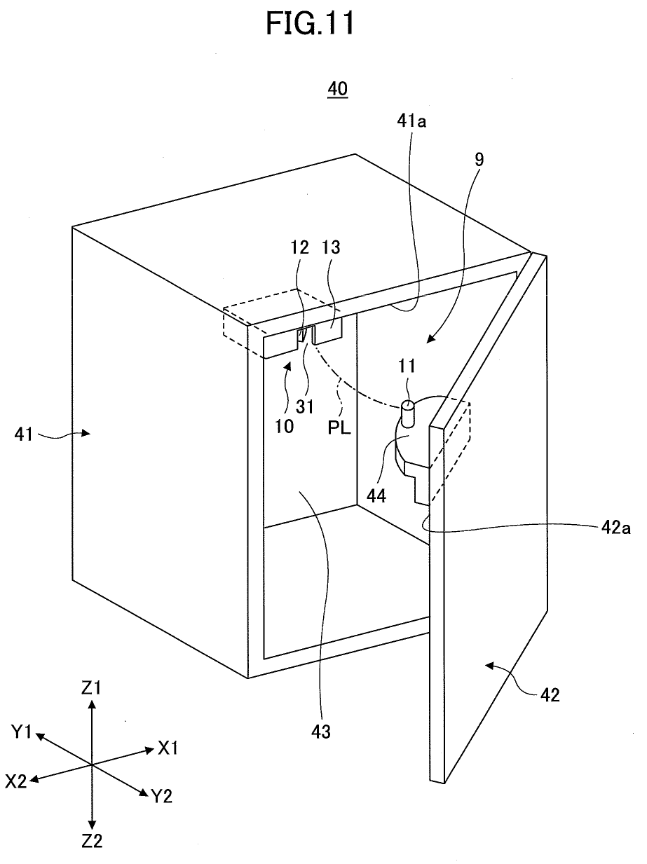

FIG. 11 illustrates an example where the opening and closing device 9 is applied to a locker 40. In FIG. 11, the same reference numerals are attached to components that are the same as the components illustrated in FIG. 1A to FIG. 10, and the description is omitted.

The locker 40 includes a storage 41, and a door 42. The storage 41 is shaped so that an opening 43 is formed on one surface of a cube shape. Inside the storage 41, a storage space for storing objects is formed. Through the opening 43, the objects to be stored can be put inside the storage 41, and the stored objects can be taken out from the storage 41.

The door 42 is attached to the storage 41 by using a hinge (not appear in the figure), so that the door 42 can be opened and closed. By closing the door 42, the storage space of the storage 41 is closed. By opening the door 42, objects to be stored can be put inside the storage 41 and the stored object can be taken out from the storage 41.

The locking system 10 forming the opening and closing device 9 is disposed on an inner surface 41a of a top plate of the storage 41. The lock pin 11 is fixed to a pin fixing member 44, which is disposed on an inner surface 42a of the door 42.

The lock pin 11 is fixed to the door 42 through the pin fixing member 44. Thus, the lock pin 11 moves as the door 42 is rotated. In a side view, the movement trajectory PL (which is indicated by the chain line) of the lock pin 11 is a line shaped trajectory that extends in the horizontal direction (the directions of the arrows Y1 and Y2 in the figure). In a plane view, the movement trajectory PL is an arc-shaped trajectory around a position of the center of the rotation of the door 42. The locking system 10 is disposed in the storage unit 41 (on the inner surface 41a), so that the groove portion 31 is positioned on the movement trajectory PL of the lock pin 11.

In the embodiment, the operation of the opening and closing device 9 that is applied to the locker 40 is the same as the operation of the opening and closing device 9 illustrated in FIG. 1A to FIG. 10. Namely, as the door 42 is moved from the open position in the direction to close, the lock pin 11 moves on the movement trajectory PL, and enters inside the locking system 10 through the groove portion 31.

Upon entering inside the locking system 10, in accordance with movement of the locking member 12 (movement in a direction perpendicular to the traveling direction of the lock pin 11, i.e., movement in the directions of X1 and X2), the lock pin 11 moves inside the heart cam portion 20.

Then, the lock pin 11 engages with the concave engaging portion 23, which is formed in the heart cam portion 20, and the lock pin 11 is in a state in which it is locked in the locking system 10. In the locked state, the door 2 is locked in a state in which the door 42 covers the opening 43 (becomes the closed state).

To open the door 42 from the closed state, the door 42 is pressed toward the storage 41 (in the direction of the arrow Y1). In accordance with the pressing operation, the lock pin 11 also moves in the direction of the arrow Y1, and the locking with the concave engaging portion 23 is released upon climbing over the protruding wall 28 (cf. FIG. 9). Consequently, locking of the lock pin 11 by the concave engaging portion 23 is released, and the door 42 is in a state in which it can be moved toward the opened state (unlocked state).

In this manner, the opening and closing device 9 can be applied not only to the cosmetic container 1 for accommodating cosmetics, such as the makeup foundation, but also to the locker 40 having the door 42 that opens and closes with respect to the storage 41. Furthermore, in addition to the above-described embodiments, the opening and closing device 9 can be applied to a drawer of a desk, and a glass door of a cupboard for dishes, for example. In this case, a lid, a door, and a drawer correspond to a movable object; and a container main body, a desk, a storage, and a cupboard for dishes correspond to a fixed object, for example. Namely, the opening and closing device 9 can be broadly applied to a system or a device for rotating or linearly moving a movable object with respect to a fixed object, as a device for locking the movable device to the fixed device in the closed state.

The locker 40 illustrated in FIG. 11 is configured such that, to release locking of the door 42 in the closed state, the door 42 is pressed in the direction of the arrow Y1 in the figure. For this reason, in the embodiment illustrated in FIG. 11, it is necessary to form, between the storage 41 and the door 42 in the closed state, a space corresponding to the distance for pressing the door 42 to release locking.

However, if having a gap between the storage and the door, when the door is locked, is not desirable, a system corresponding to the operation part 7, which is described by referring to FIGS. 1A and 1B, and FIG. 8, and the spring member 8 for biasing the pin may be provided in the door 42. The spring member 8 does not directly bias the lock pin 11. However, the spring member 8 biases the operation part 7 to which the lock pin 11 is attached. Thus, the spring member 8 biases the lock pin 11 through the operation part 7. With such a configuration, the door 42 can be locked to the storage 41 in a closely contacted state.

Next, a modified example of the locking system 10, which is illustrated in FIG. 1A to FIG. 10, is described.

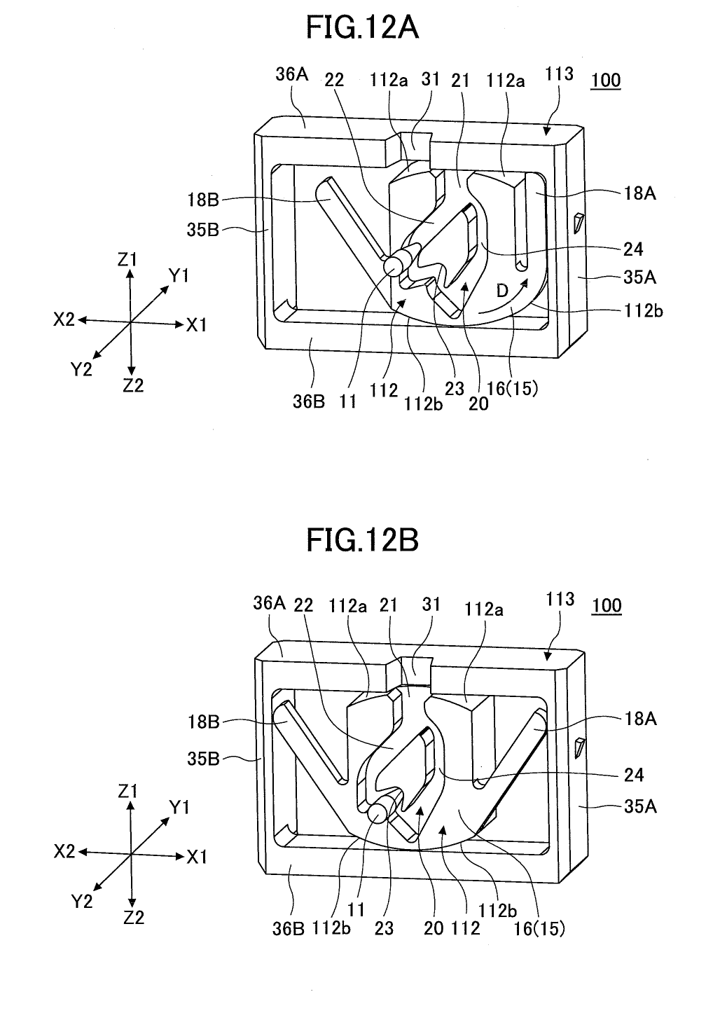

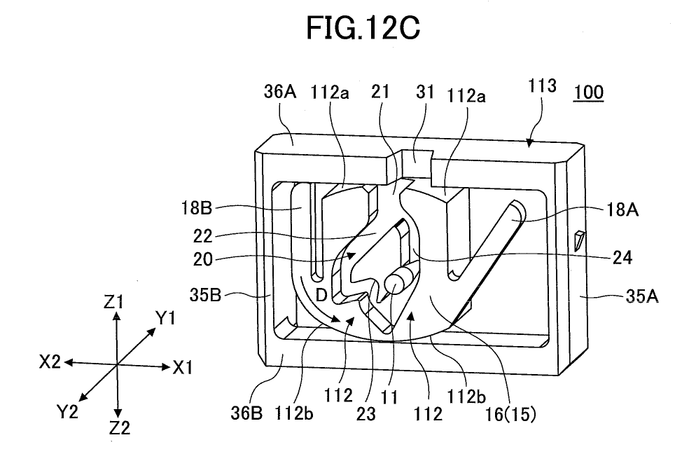

FIGS. 12A, 12B, and 12C illustrate a locking system 100, which is the modified example of the locking system 10 illustrated in FIG. 1A to FIG. 10. FIG. 12A illustrates, in the locking system 100, a state where the lock pin 11 enters the pin entrance side cam groove 22 of the heart cam portion 20. FIG. 12B illustrates, in the locking system 100, a state where the lock pin 11 is locked by the concave engaging portion 23. FIG. 12C illustrates, in the locking system 100, a state where the lock pin 11 enters the pin disengaging side cam groove 24. Note that, in FIGS. 12A, 12B, and 12C, the same reference numerals are attached to the components that are equivalent to the components illustrated in FIG. 1A to FIG. 10, and the description is omitted.

In the locking system 10 illustrated in FIG. 1A to FIG. 10, the locking member 12 moves in the guide member 13 by slidably locking the upper step portion 32 and the lower step portion 33, which are formed in the guide member 13, to the upper step portion 26 and the lower step portion 27, which are formed in the locking member 12. Thus, in the locking system 10 illustrated in FIG. 1A to FIG. 10, the locking member 12 moves only in specific directions (the directions of the arrows X1 and X2) in the guide member 13.

Whereas, in the locking system 100 according to the modified example, a locking member 112 moves in the guide member 13 in multiple directions. The configuration of the locking system 100 is described below.

Similar to the above-described locking system 10, the locking system 100 includes the lock pin 11; the locking member 112; and a guide member 113.

As illustrated in FIGS. 12A, 12B, and 12C, the locking member 112 includes an upper curved surface 112a. The upper curved surface 112a faces the upper wall portion 36A of the guide member 113 at an upper portion of the cam forming portion 16 (the main body 15). Similarly, the cam forming portion 16 (the main body 15) includes a lower curved portion 112b. The lower curved surface 112b faces the lower wall portion 36B of the guide member 113 at a lower portion of the cam forming portion 16 (the main body 15).

In the above-described locking system 10, the slide portion 17 is formed in the locking member 12. However, in the locking system 100 according to the modified example, the slide portion 17 (which includes the upper step portion 26 and the lower step portion 27) is not formed in the locking member 112. Thus, the upper step portion 32 and the lower step portion 33 are not formed in the guide member 113.

In the locking system 100 according to the modified example, the upper curved surface 112a is formed on the surface facing the upper wall portion 36A of the locking member 112, and the lower curved surface 112b is formed on the surface facing the lower wall portion 36B. Additionally, curved surface shapes of the upper curved surface 112a and the lower curved surface 112b are adjusted, so that, in the guide member 113, the locking member 112 can be rotated.

Note that the spring portions 18A and 18B are provided at both sides of the cam forming portion 16, and consequently rotation greater than or equal to a predetermined rotation angle is restricted by the contact between the spring portions 18A and 18B, and the guide member 113.

In the locking system 100 having the above-described configuration, upon the locking pin 11 entering the pin entrance side cam groove 22 of the heart cam portion 20, as illustrated in FIG. 12A, the locking member 112 is biased by the lock pin 11. Consequently, the locking member 112 moves in the direction (the direction of the arrow X1) perpendicular to the entering direction (the direction of the arrow Z2) of the lock pin 11.

At this time, the locking member 112 moves in the direction of the arrow X1 while rotating in the counterclockwise direction, which is indicated by the arrow D in FIG. 12A, because the upper curved surface 112a and the lower curved surface 112b are formed in the locking member 112.

In the state where the lock pin 11 is locked in the concave engaging portion 23, as illustrated in FIG. 12B, the locking member 112 moves to the middle position of the guide member 113. In this state, spring forces are uniformly applied to the cam forming portion 16 by the spring portions 18A and 18B, so that the cam forming portion 16 is in an upright state (the state where it is not rotated).

When the lock pin 11 is disengaged from the concave engaging portion 23, and the locked state is released, the lock pin 11 enters the pin disengaging side cam groove 24 of the heart cam portion 20, as illustrated in FIG. 12C. Upon the lock pin 11 entering the pin entrance side cam groove 22, the locking member 112 is biased by the lock pin 11, and moves in the direction (the direction of the arrow X2) perpendicular to the entering direction (the direction of the arrow Z2) of the lock pin 11.

For the case where the locking member 112 moves in the direction of the arrow X2, because the upper curved surface 112a and the lower curved surface 112b are formed in the locking member 112, the locking member 112 moves in the direction of the arrow X2 while rotating in the counterclockwise direction (the rotation which is indicated by the arrow D in FIG. 12C).

As described above, in the locking system 100 according to the modified example, when the lock pin 11 travels inside the heart cam portion 20, and the locking member 112, which is biased by the lock pin 11, moves, the locking member 112 is rotated while linearly moving in the directions of the arrows X1 and X2. The locking member 112 is rotated while moving. Thus, in the locking system 100 according to the modified example, the amount of movement of the locking member 112 in the directions of the arrows X1 and X2 when the lock pin 11 travels in the heart cam portion 20 can be reduced in comparison to the locking system 10 illustrated in FIG. 1A to FIG. 10.

Namely, when the lock pin 11 moves in the heart cam portion 20, the lock pin 11 presses the inner wall of the heart cam portion 20, and the locking member 112 is moved by this pressing force. Additionally, the lock pin 11 smoothly moves in the heart cam portion 20, as the locking member 112 is moved.

When the lock pin 11 moves in the heart cam portion 20, the lock pin 11 presses the inner wall of the heart cam portion 20 not only in the directions of the arrows X1 and X2, but also in various directions. In the locking system 10 illustrated in FIG. 1A to FIG. 10, the pressing force that is applied in a direction other than the directions of the arrows X1 and X2 is absorbed by moving the locking member 12 in the directions of the arrows X1 and X2. Consequently, when the lock pin 11 moves in the heart cam portion 20, the distance of the movement of the locking member 12 in the directions of the arrows X1 and X2 is large.

In contrast, in this modified example, by providing the upper curved surface 112a and the lower curved surface 112b in the locking member 112, the locking member 112 can be rotated inside the guide member 113. Thus, when the lock pin 11 moves in the heart cam portion 20, and when the lock pint 11 presses the inner wall of the heart cam portion 20 in a direction other than the directions of the arrows X1 and X2, the locking member 112 is rotated. This rotation is without movement in the directions of the arrows X1 and X2 in the figure.

Thus, by providing the upper curved surface 112a and the lower curved surface 112b in the locking member 112, so that the locking member 112 can be rotated in the guide member 113, the amount of the movement of the locking member 112 in the directions of the arrows X1 and X2 can be reduced. Consequently, the size of the locking system may be reduced.

In the above-described embodiment, the heart cam is used as the cam formed in the cam forming portion 16. However, another cam can be used, as long as the cam can lock the lock pin 11 as the lock pin 11 enters in accordance with the movement of the lid 3, and the engagement by the cam can be released by further operating the lid 3.

Further, in the above-described embodiment, the guide member 13 and the container main body 2 are different components. However, the guide member 13 and the container main body 2 may be integrally formed. In such a case, the size of the container main body 2 may further be reduced, and the number of the components can be reduced.

The present invention is not limited to the specifically disclosed embodiments, and various modifications and improvements may be made without departing from the scope of the present invention.

The present invention is based on and claims the benefit of priority of Japanese Priority Applications No. 2013-253494 filed on Dec. 6, 2013, and No. 2014-040136 filed on Mar. 3, 2014, the entire contents of which are hereby incorporated herein by reference.

### REFERENCE SIGNS LIST

1: CONTAINER
2: CONTAINER MAIN BODY
3: LID
4: ACCOMMODATING PORTION
5: HINGE
6: FRONT PORTION
7: OPERATION PART
8: SPRING MEMBER
9: OPENING AND CLOSING DEVICE
10, 100: LOCKING SYSTEM
11: LOCK PIN
12, 112: LOCKING MEMBER
13, 113: GUIDE MEMBER
15: MAIN BODY
16: CAM FORMING PORTION
17: SLIDE PORTION
18A, 18B: SPRING PORTION
20: HEART CAM PORTION
21: PIN INSERTION AND REMOVAL OPENING
22: PIN ENTRANCE SIDE CAM GROOVE
23: CONCAVE ENGAGING PORTION
24: PIN DISENGAGE SIDE CAM GROOVE
25: ENGAGING WALL
26: UPPER STEP PORTION
27: LOWER STEP PORTION
31: GROOVE PORTION
32: UPPER STEP PORTION
33: LOWER STEP PORTION
34A, 34B: INSTALLATION PROTRUSION
35A, 35B: SIDE WALL PORTION
112A: UPPER CURVED SURFACE
112B: LOWER CURVED SURFACE
PL: MOVEMENT TRAJECTORY
CL: CENTER LINE

### CITATION LIST

### Patent Literature

[PTL 1] PATENT DOCUMENT 1: JAPANESE UNEXAMINED PATENT PUBLICATION NO. 2004-231245
[PTL 2] PATENT DOCUMENT 2: JAPANESE UNEXAMINED UTILITY MODEL PUBLICATION NO. S53-025822

1. A locking system for fixing a second member to a first member, the second member being pivotably attached to the first member, the locking system comprising:
a lock pin;
a locking member that moves as the lock pin travels; and
a first biasing member that biases the locking member,
wherein the locking member includes a cam groove, wherein the lock pin enters and travels inside the cam groove in accordance with a pivoting movement of the second member,
wherein the cam groove includes a locking portion that locks the lock pin, upon the second member being moved to a position at which the second member is fixed to the first member, and the locking portion releases the lock pin, upon the lock pin being pressed while in a locked state, and
wherein a moving direction of the locking member is set to be different from a direction in which the lock pin enters the cam groove.

2. The locking system according to claim 1,
wherein the moving direction of the locking member is set to be a direction perpendicular to the direction in which the lock pin travels the cam groove.

3. The locking system according to claim 1,
wherein the locking member and the first biasing member are integrally formed as one component.

4. The locking system according to claim 1, further comprising:
a guide member that includes the locking member, and that guides movement of the locking member.

5. The locking system according to claim 1,
wherein the cam groove forms a heart cam.

6. The locking system according to claim 1, further comprising:
a second biasing member that biases the lock pin toward the locking portion.

7. An opening and closing device including the locking system according to claim 1.

8. The opening and closing device according to claim 7,
wherein the moving direction of the locking member is a direction perpendicular to the direction in which the lock pin travels the cam groove.

9. The opening and closing device according to claim 7,
wherein the locking member and the first biasing member are integrally formed as one component.

10. The opening and closing device according to claim 7,
wherein the locking system further comprises:
a guide member that includes the locking member, and that guides movement of the locking member.

11. The opening and closing device according to claim 7,
wherein the cam groove forms a heart cam.

12. The opening and closing device according to claim 7,
wherein the locking system further comprises:
a second biasing member configured to bias the lock pin toward the locking portion.
